(19) United States
(12) Patent Application Publication
(10) Pub. No.: US 2003/0225910 A1
(43) Pub. Date: Dec. 4, 2003

(54) Host resolution for IP networks with NAT

(76) Inventors: Albert Pan, San Jose, CA (US); Henry Jen, San Jose, CA (US)

Correspondence Address: James H. Salter, Blakely, Sokoloff, Taylor & Zafman LLP, Seventh Floor, 12400 Wilshire Boulevard, Los Angeles, CA, 90025-1030, US

(21) Appl. No.: 10/161,190

(22) Filed: May 30, 2002

(51) Int. Cl. G06F 15/16; G06F 15/173

(52) U.S. Cl. 709/245; 709/249

(57) ABSTRACT

A network system is provided to route messages within a Network Address Translation (NAT) environment. The network system registers address information of a Private Network System (PNS) with a System Node Master (SNM). The network system locates system nodes of the PNS by issuing a request to the SNM. The network system provides communication between the system nodes and a remote user.

### FIELD OF THE INVENTION

This invention relates to a network system for routing messages. More specifically, this invention relates to routing messages between different private networks within a Network Address Translation (NAT) environment.

### BACKGROUND OF THE INVENTION

As Internet Protocol (IP) addresses become a limited resource, most users only get a limited number of IP addresses from their Internet Service Provider (ISP). If there are more computers than the number of assigned available IP addresses, NAT is used to share the same public IP address for more than one computer in a private IP network. By introducing NAT into a distributed environment that is composed of multiple private network segments, it increases the system administrator's job to set up the node to node communication configuration.

However, currently available NAT environments do not provide an efficient way for system nodes to communicate with each other. For example, although IP Proxy servers have been used between a private network and a public network, the conventional proxy server design is limited to data communications between a private node and a public node. The conventional IP proxy server design is not efficient for communication between private nodes. Further, conventional proxies are not suitable for a collaborated central management.

Another disadvantage of the current NAT environment is that in a typical private network set up, system nodes get dynamically assigned IP address through a Dynamic Host Configuration Protocol (DHCP), so that a system node of the private network does not know the assigned IP addresses of other system nodes, thus the system nodes of a private network cannot communicate with each other.

Still another disadvantage of the current NAT environment is that in a typical Domain Name Server (DNS) configuration, system nodes of a private network must have static IP addresses so that system nodes can communicate with each other by checking a name-address look-up table.

Still another disadvantage of the current NAT environment is that the ordinary Network Proxy server and ordinary DNS cannot locate a system node if the system node does not have a public appearance (i.e. a unique IP address).

Therefore, it becomes necessary to improve the configuration scheme and relay the messages from node to node between different private networks. It is also necessary to improve the configuration scheme and relay messages from a remote user to system nodes.

### SUMMARY OF THE INVENTION

A system and method for routing messages between different private networks within an NAT environment is described. In one embodiment of the invention, the system and method comprises registering address information of a Private Network System (PNS) with a System Node Master (SNM), locating a system node of the PNS by issuing a request to the SNM, and communicating with the system node.

Other features and advantages of the present invention will be apparent from the accompanying drawings, and from the detailed description, which follows below.

### BRIEF DESCRIPTION OF THE DRAWINGS

The present invention is illustrated by way of example and not intended to be limited by the figures of the accompanying drawings in which like references indicate similar elements and in which:

FIG. 1 is a system diagram of one embodiment of an IP network system.

FIG. 2 is a flow diagram illustrating an embodiment of a process for system nodes within a private network system to communicate with each other.

FIG. 3 is a flow diagram illustrating an embodiment of a process for system nodes of different private network systems to communicate with each other.

FIG. 4 is a flow diagram illustrating an embodiment of a process for a remote user to communicate with a system node.

### DETAILED DESCRIPTION

A method and apparatus for routing messages between different private networks within an NAT environment is described. In the following detailed description of embodiments of the invention, reference is made to the accompanying drawings in which like references indicate similar elements, and in which are shown by way of illustration specific embodiments in which the invention may be practiced. These embodiments are described in sufficient detail to enable those of ordinary skill in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

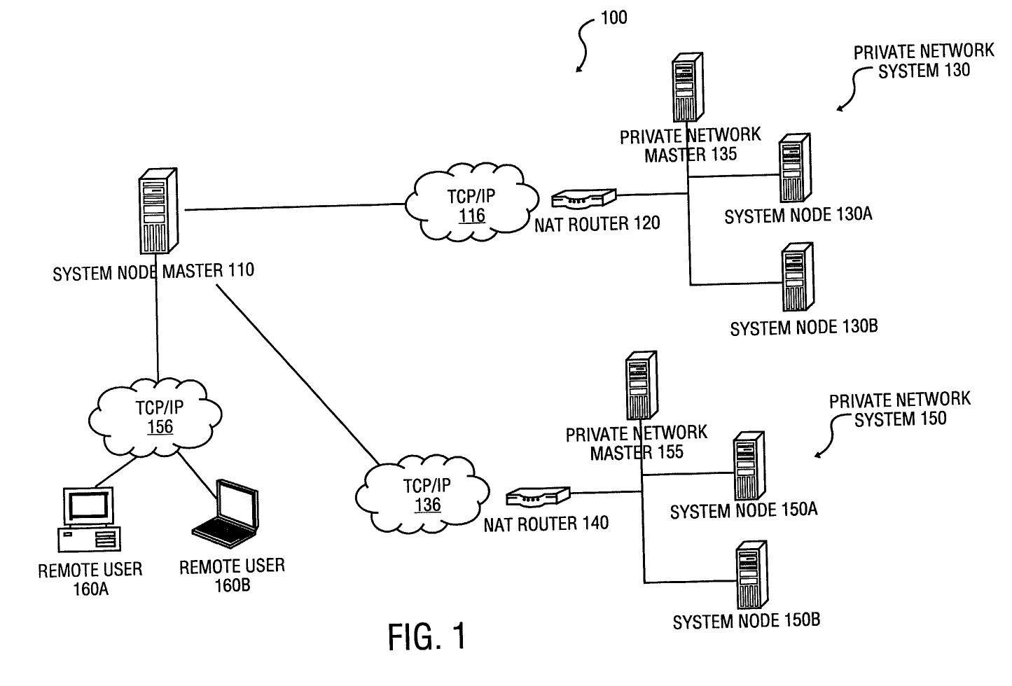

FIG. 1 is a system diagram of one embodiment of an IP network system. Referring to FIG. 1, the network system 100 includes a system node master (SNM) 110. The SNM 110 is connected with NAT routers via a conventional data network, such as one using the well-known Transmission Control Protocol/Internet Protocol (TCP/IP), so that the SNM 110 and the NAT routers can communicate with each other via an internet connection. In one embodiment, the SNM 110 is connected with NAT routers 120 and 140, but the invention is not so limited. The SNM 110 may be connected with only one NAT router or as many NAT routers as necessary. Each NAT router includes at least one public IP address and is connected with one Private Network System (PNS). Referring to FIG. 1, the NAT router 120 is connected with a PNS 130, and the NAT router 140 is connected with a PNS 150. The PNS 130 includes a Private Network Master (PNM) 135 and a plurality of system nodes 130A, 130B, etc. The PNS 150 includes a PNM 155 and a plurality of system nodes 150A, 150B, etc. In one embodiment, the system nodes are computers. The detailed description that follows illustrates the method to enable the system nodes to communicate with each other.

In one embodiment, remote users can be connected with the SNM 110 via the internet so that the remote users can communicate with system nodes. Referring to FIG. 1, remote users 160A and 160B are connected with the SNM via TCP/IP link 155, but the invention is not so limited. The SNM 110 can be connected with only one remote user or as many remote users as necessary. The detailed description that follows illustrates the method to enable the remote users to communicate with the system nodes.

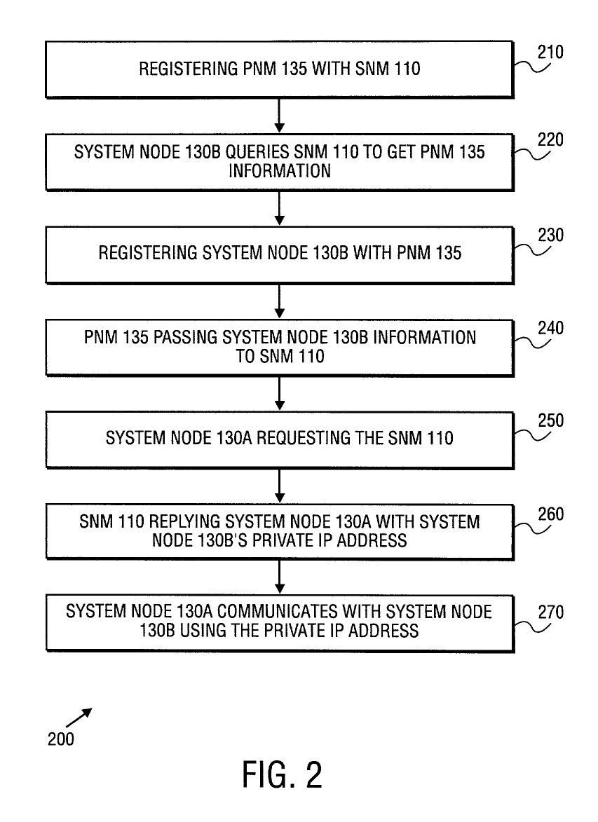

FIG. 2 is a flow diagram illustrating an embodiment of a process for system nodes within a private network system to communicate with each other. In one embodiment, FIG. 2 illustrates a process for system node 130A to communicate with system node 130B.

In one embodiment, every system node in the network system knows the IP address of the SNM 110 and is able to communicate with the SNM 110. Each system node is configured with information of the SNM 110 and includes a system node identification. In addition, each PNM is configured with information of the SNM 110 and includes a private domain identification. The system node can ask the SNM 110 to get the private IP address of the PNS. Furthermore, the SNM 110 is configured with a list of private domain identifiers of the corresponding PNS and an association of system nodes and the corresponding PNS.

Referring to FIG. 2, at processing block 210, processing logic registers the PNM 135 with the SNM 110. At processing block 220, the system node 130B requests the SNM 110 to get information of the PNM 135. At processing block 230, processing logic registers system node 130B information with the PNM 135. At processing block 240, processing logic passes system node 130B information from the PNM 135 to the SNM 110. In one embodiment, the system node 130B registers a system node identification with the SNM 110. At processing block 250, when system node 130A tries to communicate with system node 130B, the system node 130A sends a query to the SNM 110. At processing block 260, the SNM 110 replies to the system node 130A with a private IP address of the system node 130B. At processing block 270, after system node 130A gets the reply from SNM 110, the system node 130A can use the private IP address of the system 130B to communicate directly with the system node 130B. Therefore, system nodes within a PNS can communicate with each other.

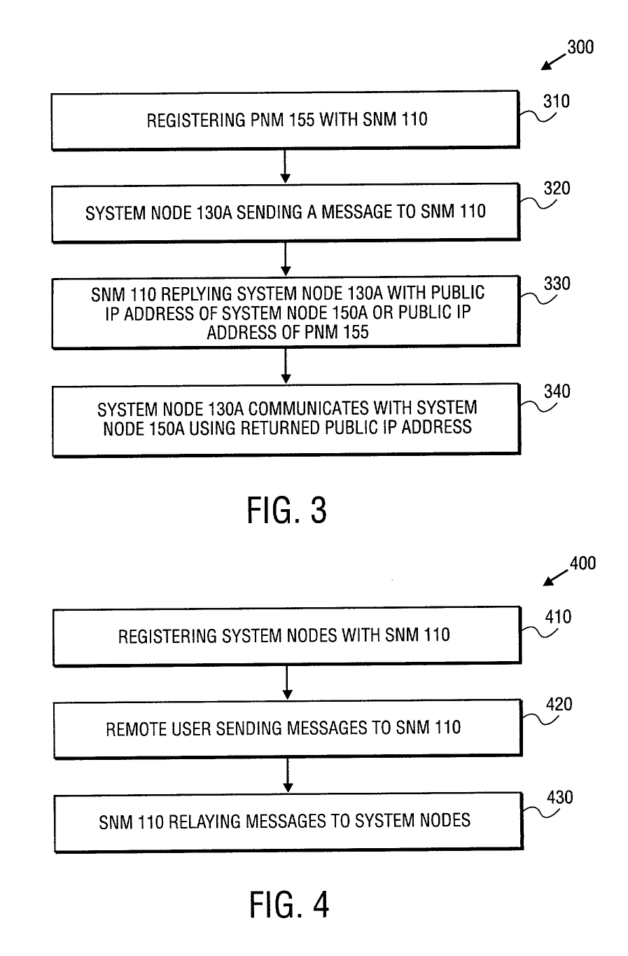

FIG. 3 is a flow diagram illustrating an embodiment of a system and process with which a system node in a first PNS may communicate with a different system node in a second PNS. In one embodiment, FIG. 3 illustrates a process by which system node 130A may communicate with system node 150A.

Referring to FIG. 3 at processing block 310, processing logic registers PNM 155 with the SNM 110. In one embodiment, the PNM 155 registers a private domain identification with the SNM 110. The PNM 155 also informs the SNM 110 whether the PNM 155 has proxy capability to relay messages to system nodes. In one embodiment, the PNM 155 is capable of relaying messages so that the system node communication can go through a proxy relay. Thus, the system node 150A does not need to have a public IP address entry in the SNM 110. In another embodiment, the PNM 155 is not capable of relaying messages. Thus the system node 150A needs a public IP address entry in the SNM 110.

At processing block 320, when the system node 130A tries to communicate with the system node 150A, system node 130A sends a message to the SNM 110. At processing block 330, in one embodiment, based on the node communication type of system node 150A, the SNM 110 replies to the system node 130A with a public IP address of the PNM 155. In another embodiment, the SNM 110 can provide the system node 130A with a public IP address of system node 150A. At processing block 340, after the system node 130A gets the reply from SNM 110, the system node 130A can use the returned IP address to communicate with the system node 150A. Therefore, a system node in a first PNS can communicate with a different system node in a second PNS.

FIG. 4 is a flow diagram illustrating an embodiment of a process for a remote user to communicate with a system node. In one embodiment, FIG. 4 illustrates a process for remote user 160A to communicate with system nodes.

Referring to FIG. 4 at processing block 410, processing logic registers address information of system nodes with the SNM 110. At processing block 420, the remote user 160A can send messages to the SNM 110. At processing block 430, the SNM 110 can relay all messages from the remote user 160A to the appropriate system nodes. Therefore, the remote user only needs to communicate with the SNM 110, which relays all messages to the appropriate system node.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A network system comprising:
a System Node Master (SNM);
at least one Network Address Translation (NAT) router connected with the SNM; and
at least one Private Network System (PNS), wherein each PNS is connected with each NAT router, wherein each PNS includes a Private Network Master (PNM) and at least one system node, and wherein a requesting party can communicate with the system node by issuing a request to the SNM.

2. The network system of claim 1, wherein the system node is a computer.

3. The network system of claim 1, wherein each system node registers a system node identification with the SNM.

4. The network system of claim 1, wherein each PNM registers a private domain identification with the SNM.

5. The network system of claim 1, wherein the requesting party is one of the at least one system node.

6. The network system of claim 5, wherein the requesting party can obtain a private IP address of another system node in a same PNS from the SNM.

7. The network system of claim 6, wherein the requesting party communicates with each system node using the obtained private IP address.

8. The network system of claim 5 wherein the requesting party can obtain a public IP address of each system node of a different PNS from the SNM.

9. The network system of claim 8, wherein the requesting party communicates with each system node using the obtained public IP address.

10. The network system of claim 5, wherein the requesting party can obtain a public IP address of each PNM from the SNM.

11. The network system of claim 10, wherein the requesting party communicates with each system node using the obtained public IP address of each PNM.

12. The network system of claim 1, wherein the requesting party is a remote user.

13. The network system of claim 12, wherein the requesting party requests the SNM to relay messages to the system node.

14. A method within a Network Address Translation (NAT) environment, the method comprising:
registering address information of a Private Network System (PNS) with a System Node Master (SNM);
locating a system node of the PNS by issuing a request to the SNM; and
communicating with the system node.

15. The method of claim 14, wherein the system node is a computer.

16. The method of claim 14, wherein communicating with the system node includes relaying messages from the SNM to the system node.

17. The method of claim 14, wherein locating the system node includes obtaining a private IP address of the system node in a same PNS from the SNM.

18. The method of claim 14, wherein locating the system node includes obtaining a public IP address of the system node of a different PNS from the SNM.

19. The method of claim 14, wherein locating the system node includes obtaining a public IP address of the PNM from the SNM.

20. A network system comprising:
a System Node Master (SNM);
at least one Network Address Translation (NAT) router connected with the SNM;
at least one Private Network System (PNS), wherein each PNS is connected with each NAT router;
means for registering address information of the PNS with the SNM; and
means for communicating with a system node of the PNS by issuing a request to the SNM.

21. The network system of claim 20, wherein communicating with the system node includes relaying messages from the SNM to the system node.

22. The network system of claim 20, wherein the means for communicating includes means for obtaining a private IP address of the system node in a same PNS from the SNM.

23. The network system of claim 20, wherein the means for communicating includes means for obtaining a public IP address of the system node of a different PNS from the SNM.

24. The network system of claim 20, wherein the means for communicating includes means for obtaining a public IP address of the PNM from the SNM.

25. A computer readable medium containing executable instruction which, when executed in the process system, causes the system to perform a method for routing messages within a Network Address Translation (NAT) environment, the method comprising:
registering address information of a Private Network System (PNS) with a System Node Master (SNM);
locating a system node of the PNS by issuing a request to the SNM; and
communicating with the system node.

26. The computer readable medium of claim 25, wherein the system node is a computer.

27. The computer readable medium of claim 25, wherein communicating with the system node includes relaying messages from the SNM to the system node.

28. The computer readable medium of claim 25, wherein locating the system node includes obtaining a private IP address of the system node in a same PNS from the SNM.

29. The computer readable medium of claim 25, wherein locating the system node includes obtaining a public IP address of the system node of a different PNS from the SNM.

30. The computer readable medium of claim 25, wherein locating the system node includes obtaining a public IP address of the PNM by requesting the SNM.
